(19) United States
(12) Patent Application Publication
(10) Pub. No.: US 2025/0029980 A1
(43) Pub. Date: Jan. 23, 2025

(54) ALL-SOLID-STATE BATTERY INCLUDING EXPANDABLE ANODE LAYER AND METHOD OF OPERATION THEREOF

(71) Applicants: Hyundai Motor Company, Seoul (KR); Kia Corporation, Seoul (KR); IUCF-HYU (Industry-University Cooperation Foundation Hanyang University), Seoul (KR)

(72) Inventors: Ki Yoon BAE, Seoul (KR); Sam Ick SON, Suwon-si (KR); Ji Young KIM, Suwon-si (KR); Yun Jung LEE, Seoul (KR); Da Young JUN, Seoul (KR); Se Hwan PARK, Seoul (KR); Ji Eun JUNG, Seoul (KR)

(21) Appl. No.: 18/416,252

(22) Filed: Jan. 18, 2024

(30) Foreign Application Priority Data
Jul. 19, 2023 (KR) 10-2023-0094075

(51) Int. Cl. H01M 4/134; H01M 4/02; H01M 10/0562

(52) U.S. Cl. CPC H01M 4/134; H01M 2004/021; H01M 2004/027; H01M 10/0562; H01M 2300/0065

(57) ABSTRACT

Disclosed is an all-solid-state battery including an anode layer that expands and accommodates lithium metal during charging, and a method of operation thereof. The all-solid battery includes an anode current collector, an anode layer disposed on the anode current collector, a solid electrolyte layer disposed on the anode layer, a cathode active material layer disposed on the solid electrolyte layer, and a cathode current collector disposed on the cathode active material layer. The anode layer comprises particles comprising a metal capable of allying with lithium and interparticular pores.

### CROSS-REFERENCE TO RELATED APPLICATION

This application claims, under 35 U.S.C. § 119 (a), the benefit of priority from Korean Patent Application No. 10-2023-0094075, filed on Jul. 19, 2023, the entire contents of which are incorporated herein by reference.

### TECHNICAL FIELD

The present disclosure relates to an all-solid-state battery including an anode layer that expands and accommodates lithium metal during charging, and a method of operation thereof.

### BACKGROUND

All-solid-state batteries are made up of solid components, so there is generally less risk of fire and explosion than with lithium ion batteries that use flammable organic solvents as electrolytes. Additionally, in all-solid-state batteries, there may not be safety issues even when lithium metal is used as an anode active material because the mechanical strength of the solid electrolyte is high. Moreover, when using an anodeless structure in which lithium is used as an anode active material but lithium is not included during battery assembly, and when lithium supplied by a cathode active material is deposited on the anode current collector, it is possible to further increase energy density.

### SUMMARY OF THE DISCLOSURE

An object of the present disclosure is to provide an all-solid-state battery including an anode layer capable of accommodating a large amount of lithium metal during charging.

The objects of the present disclosure are not limited to the foregoing. The objects of the present disclosure will be able to be clearly understood through the following description and to be realized by the means described in the claims and combinations thereof.

An implementation of the present disclosure provides an all-solid-state battery, including an anode current collector, an anode layer disposed on the anode current collector, a solid electrolyte layer disposed on the anode layer, a cathode active material layer disposed on the solid electrolyte layer, and a cathode current collector disposed on the cathode active material layer, in which the anode layer can include particles including a metal capable of forming an alloy with lithium and interparticular pore.

The metal can include one or more of magnesium (Mg), silver (Ag), zinc (Zn), bismuth (Bi), tin (Sn), and combinations thereof.

The average particle size (D50) of the particles may be 300 nm to 700 nm.

The particles may maintain a spherical or elliptical shape in the anode layer.

The anode layer may be composed of the particles alone.

The particles may further include an alloy of the metal and lithium.

Lithium metal may be accommodated in the interparticular pores during charging of the all-solid-state battery.

Alloying between the particles and lithium may occur during charging of the all-solid-state battery.

During charging of the all-solid-state battery, lithium metal may be deposited on the surface of the particles and thus a distance between the particles may be increased, so that the interparticular pores may be enlarged, and lithium metal may be accommodated in the interparticular pores.

The anode layer may satisfy Equation 1 below.

$$2 \leq {T}_{2} / {T}_{1} \leq 5.9 \qquad [ Equation 1 ]$$

Here, T₁ may be the thickness of the anode layer when the all-solid-state battery is fully discharged, and T₂ may be the thickness of the anode layer when the all-solid-state battery is fully charged.

The intensity of peaks at 2θ=32°±0.5°, 34°±0.5°, and 37°±0.5° appearing in results of X-ray diffraction analysis of the anode layer may decrease with the progress of charging and discharging.

The intensity of peaks at 2θ=36°±0.5° appearing in results of X-ray diffraction analysis of the anode layer may increase with the progress of charging and discharging.

### BRIEF DESCRIPTION OF THE DRAWINGS

The above and other features of the present disclosure will now be described in detail with reference to certain exemplary implementations thereof illustrated in the accompanying drawings, which are given hereinbelow by way of illustration only, and thus are not limitative of the present disclosure, and wherein:

FIG. 1 shows a schematic drawing of an example all-solid-state battery according to the present disclosure;

FIG. 2 shows a schematic drawing of the example all-solid-state battery according to the present disclosure when it is fully charged;

FIG. 3A illustrates an internal structure of an example anode layer according to the present disclosure;

FIG. 3B illustrates an internal structure of the anode layer of FIG. 3A during charging;

FIG. 3C illustrates an internal structure of the anode layer of FIG. 3A upon full charging;

FIG. 4A is an example transmission electron microscope (TEM) image showing a magnesium powder according to the present disclosure;

FIG. 4B is an example TEM image showing a cross-sectional view of a solid electrolyte layer and an anode layer of a half cell according to the present disclosure;

FIG. 5A is an example scanning electron microscope (SEM) image showing a cross-sectional view of the anode layer upon charging of the half cell at a capacity of 1 mAh/cm²;

FIG. 5B is an example SEM image showing a cross-sectional view of the anode layer upon charging of the half cell at a capacity of 2 mAh/cm²;

FIG. 5C is an example SEM image showing a cross-sectional view of the anode layer upon charging of the half cell at a capacity of 4 mAh/cm²;

FIG. 5D shows example results of analyzing the same cross-sectional view as in FIG. 5A using an energy dispersive spectrometer (EDS);

FIG. 5E shows example results of analyzing the same cross-sectional view as in FIG. 5B using an energy dispersive spectrometer;

FIG. 5F shows example results of analyzing the same cross-sectional view as in FIG. 5C using an energy dispersive spectrometer;

FIG. 6 shows example TEM images showing the particles removed from the anode layer that is charged upon 10 charging/discharging cycles of the half cell according to Example 1;

FIG. 7 shows example results of X-ray diffraction analysis of the anode layer of the half cell according to Example 1;

FIG. 8 shows example results of measuring Coulombic efficiency upon charging/discharging of the half cells according to Example 1 and Comparative Example under conditions of 0.5 mA/cm² and 1 mAh/cm²;

FIG. 9 shows example results of measuring Coulombic efficiency upon charging/discharging of the half cells according to Example 1 and Comparative Example under conditions of 0.5 mA/cm² and 2 mAh/cm²;

FIG. 10 shows example voltage profiles in the first cycle and the second cycle upon charging/discharging of the half cell according to Example 1 under conditions of 0.5 mA/cm² and 2 mAh/cm²; and

FIG. 11 shows example cycle-capacity and cycle-Coulombic efficiency of a full cell according to Example 2.

### DETAILED DESCRIPTION

The above and other objects, features and advantages of the present disclosure will be more clearly understood from the following preferred implementations taken in conjunction with the accompanying drawings. However, the present disclosure is not limited to the implementations disclosed herein, and may be modified into different forms. These implementations are provided to thoroughly explain the disclosure and to sufficiently transfer the spirit of the present disclosure to those skilled in the art.

Throughout the drawings, the same reference numerals will refer to the same or like elements. Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

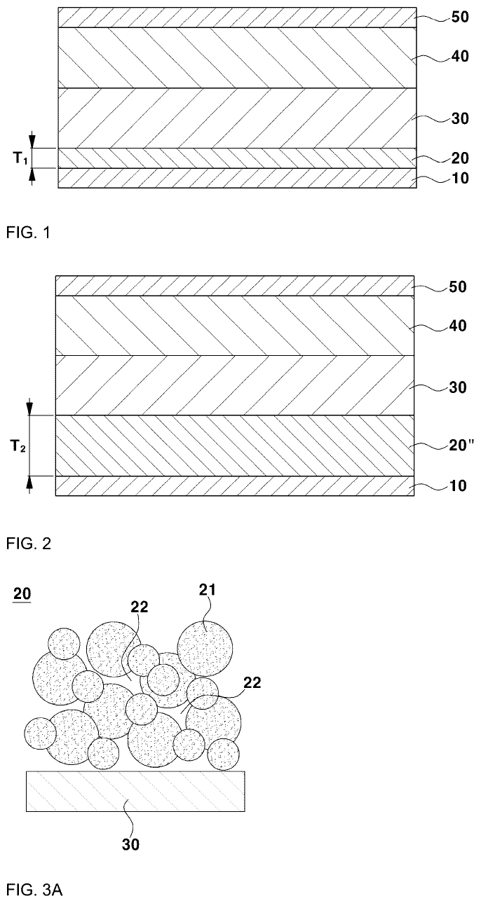

FIG. 1 shows an all-solid-state battery according to the present disclosure. With reference thereto, the all-solid-state battery may be configured such that an anode current collector 10, an anode layer 20, a solid electrolyte layer 30, a cathode active material layer 40, and a cathode current collector 50 are stacked. FIG. 1 shows the all-solid-state battery that is fully discharged. Here, full discharging may mean that a state of charge (SOC) is zero.

FIG. 2 shows the all-solid-state battery according to the present disclosure that is fully charged. Here, full charging may mean that SOC is 100. Lithium ions (Li+) released from the cathode active material layer 40 move to the anode layer 20″ through the solid electrolyte layer 30. The lithium ions (Lit) are reduced at the interface between the solid electrolyte layer 30 and the anode layer 20″ and are accommodated in the form of lithium metal in the anode layer 20″. Since the anode layer 20″ according to the present disclosure expands and accommodates lithium metal during charging, it is possible to store a large amount of lithium metal compared to conventional batteries, which will be described later.

The anode current collector 10 can be a plate-type substrate having electrical conductivity. Specifically, the anode current collector 10 can be in the form of a sheet, a thin film, or a foil, among others.

The anode current collector 10 can include a material that does not react with lithium. Specifically, the anode current collector 10 can include one or more of nickel (Ni), copper (Cu), stainless steel, and combinations thereof.

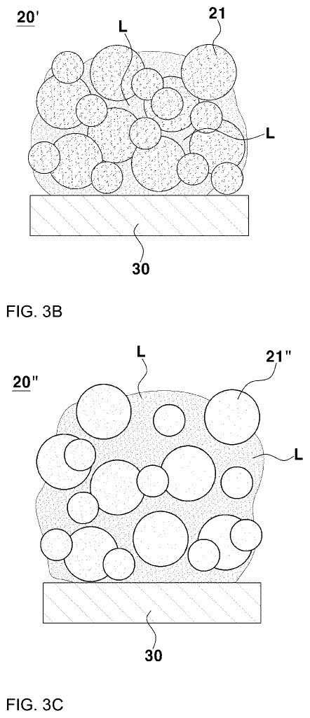

FIG. 3A is a reference view showing the internal structure of the anode layer 20 according to the present disclosure. Specifically, FIG. 3A shows the anode layer 20 before charging of the all-solid-state battery according to the present disclosure or upon full discharging thereof.

The anode layer 20 can include particles 21 and interparticular pores 22. Each interparticle pore 22 may be a space between any one particle 21 and another particle 21 adjacent thereto.

The particles 21 can include a metal capable of forming an alloy with lithium. The metal can include one or more of magnesium (Mg), silver (Ag), zinc (Zn), bismuth (Bi), tin (Sn), and combinations thereof.

An average particle size (D50) of the particles 21 can be 300 nm to 700 nm. The average particle size (D50) of the particles 21 is a factor that can determine the size of the interparticular pores 22, and when D50 falls within the above numerical range, the interparticular pores 22 having a size desired in the present disclosure may be formed. The average particle size (D50) may be measured using a commercially available laser diffraction scattering-type particle size distribution analyzer, for example, a Microtrac particle size distribution analyzer. Alternatively, 200 particles may be arbitrarily extracted from the electron micrograph and the average particle diameter thereof may be calculated.

In some cases, the particles 21 can maintain a spherical or elliptical shape in the anode layer 20. Therefore, when the all-solid-state battery is repeatedly charged and discharged, problems such as disappearance of the interparticular pores 22 due to aggregation of the particles 21 is less likely to occur.

The anode layer 20 can be composed of the particles 21 alone. Specifically, in some cases, the anode layer 20 may not include an active material capable of intercalating and deintercalating lithium ions, such as a silicon-based anode active material, a carbon-based anode active material, etc. Also, the anode layer 20 may not include an electrolyte having lithium ion conductivity, such as a solid electrolyte, a polymer electrolyte, etc. Also, the anode layer 20 may not include a binder that allows the particles 21 to bind to each other.

The particles 21 can further include an alloy of the metal and lithium. The particles 21 can include the metal, an alloy of the metal and lithium, or the metal and the alloy. This will be described in more detail through a mechanism of charging of the all-solid-state battery according to the present disclosure.

FIG. 3B shows the internal structure of the anode layer 20′ during charging of the all-solid-state battery according to the present disclosure. FIG. 3C shows the internal structure of the anode layer 20″ upon full charging of the all-solid-state battery according to the present disclosure.

When charging of the all-solid-state battery starts, lithium ions (Li+) released from the cathode active material layer 40 move to the anode layer 20 through the solid electrolyte layer 30. Since the conduction of electrons through the particles 21 in the anode layer 20 is much faster than the conduction of lithium ions (Li+) through the solid electrolyte layer 30, most lithium ions (Li+) are reduced and deposited on the interface between the solid electrolyte layer 30 and the anode layer 20.

With reference to FIG. 3B, since alloying between the metal for the particles 21 and lithium is relatively slow, an alloy of the metal and lithium may not be formed at the initial stage of charging. Lithium metal L can grow using, as a seed, lithium metal deposited on the interface between the solid electrolyte layer 30 and the anode layer 20, and the lithium metal L is accommodated in the interparticular pores 22 through a creep phenomenon. Therefore, the interface between the solid electrolyte layer 30 and the anode layer 20′ may not be separated by the growing lithium metal L, and lithium dendrites may not grow. The creep phenomenon can mean that a certain material undergoes deformation with time when subjected to stress equal to or less than yield strength. The present disclosure stores lithium through Coble creep. Since Coble creep occurs at a low temperature, it is advantageous for low-temperature operation of an all-solid-state battery. For example, the all-solid-state battery according to the present disclosure may operate at about 25° C. to 45° C. to take advantage of such phenomenon. Moreover, the all-solid-state battery can be charged while applying a predetermined pressure thereto so that the creep phenomenon occurs more efficiently. For example, the all-solid-state battery may operate in a state in which a pressure of about 1 MPa to 30 MPa is applied in a stacking direction of the all-solid-state battery.

With reference to FIG. 30, when charging of the all-solid-state battery continues, particles 21′ made of an alloy of the metal and lithium are formed. Accordingly, lithium metal is deposited on the surface of the particles 21′, whereby gaps between the particles 21′ widen and interparticular pores are enlarged. Specifically, the expanded anode layer 20″ is formed and lithium metal L is accommodated again in the enlarged interparticular pores.

The anode layer 20, 20″ according to the present disclosure and accommodating lithium metal according to the mechanism described above may satisfy Equation 1 below.

$$2 \leq {T}_{2} / {T}_{1} \leq 5.9 \qquad [ Equation 1 ]$$

Here, T₁ may be the thickness of the anode layer 20 upon full discharging of the all-solid-state battery as shown in FIGS. 1, and T₂ may be the thickness of the anode layer 20″ upon full charging of the all-solid-state battery as shown in FIG. 2. As such, full discharging may mean that a state of charge (SOC) is 0, and full charging may mean that SOC is 100. Also, Equation 1 may be applied when the charge capacity of the all-solid-state battery is 4 mAh/cm² or less. The lower limit of the charge capacity is not particularly limited, and can be 0.1 mAh/cm² or more, 0.5 mAh/cm² or more, or 1 mAh/cm² or more.

The anode layer 20 according to the present disclosure that satisfies Equation 1 is capable of accommodating a large amount of lithium compared to conventional batteries.

Here, T₁ is not particularly limited, but can be 1 μm to 10 μm, and T₂ may have an appropriate value depending on T₁ and Equation 1 above.

The solid electrolyte layer 30 can be disposed between the cathode active material layer 40 and the anode layer 20 and can include a solid electrolyte having lithium ion conductivity.

The solid electrolyte can include one or more of an oxide-based solid electrolyte, a sulfide-based solid electrolyte, a polymer electrolyte, and combinations thereof.

The sulfide-based solid electrolyte is not particularly limited, and examples thereof can include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like.

Examples of the oxide-based solid electrolyte can include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the polymer electrolyte can include a gel polymer electrolyte, a solid polymer electrolyte, and the like.

The solid electrolyte layer 30 can further include a binder. Examples of the binder can include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode active material layer 40 can include a cathode active material, a solid electrolyte, a conductive material, a binder, and the like.

The cathode active material is capable of reversibly intercalating and deintercalating lithium ions (Li+). The cathode active material can include an oxide active material. Examples of the oxide active material can include a rock-salt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-containing active material such as Li₂FeSiO₄, Li₂MnSiO₄, etc., a rock-salt-layer-type active material in which a portion of a transition metal is substituted with a different metal, such as LiNi_{0.8}CO_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is selected from among Al, Mg, Co, Fe, Ni, and Zn, 0<x+y<2), lithium titanate such as Li₄Ti₅O₁₂, and the like.

The solid electrolyte may be selected from among an oxide-based solid electrolyte, a sulfide-based solid electrolyte, a polymer electrolyte, and combinations thereof. The solid electrolyte included in the cathode active material layer 40 may be the same as or different from that of the solid electrolyte layer 30.

The sulfide-based solid electrolyte is not particularly limited, and examples thereof can include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—LiZO—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂—LiₓMO_{y} (in which x and y are positive numbers, and M is any one selected from among P, Si, Ge, B, Al, Ga, and In), Li₁₀GeP₂S₁₂, and the like.

Examples of the oxide-based solid electrolyte can include perovskite-type LLTO (Li₃ₓLa_{2/3-x}TiO₃), phosphate-based NASICON-type LATP (Li₁₊ₓAlₓTi₂₋ₓ (PO₄)₃), and the like.

Examples of the polymer electrolyte can include a gel polymer electrolyte, a solid polymer electrolyte, and the like.

Examples of the conductive material can include carbon black, conductive graphite, ethylene black, carbon fiber, graphene, and the like.

Examples of the binder can include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like. The binder included in the cathode active material layer 40 can be the same as or different from that of the solid electrolyte layer 30.

The cathode current collector 50 may be a plate-type substrate having electrical conductivity. Specifically, the cathode current collector 50 may be in the form of a sheet or a thin film.

The cathode current collector 50 may one or more of indium, copper, magnesium, aluminum, stainless steel, iron, and combinations thereof.

A better understanding of the present disclosure may be obtained through the following examples. These examples are merely set forth to illustrate the present disclosure, and are not to be construed as limiting the scope of the present disclosure.

### Example 1

A half cell with lithium metal as a counter electrode was manufactured as follows.

A solid electrolyte layer was formed by placing about 90 mg of L₆PS₅Cl_{0.5}Br_{0.5} powder in a mold having an inner diameter of about 10 mm and pressing the same at about 200 MPa. An anode layer was formed by placing magnesium powder on one side of the solid electrolyte layer and pressing the same at about 380 MPa. A half cell was manufactured by attaching a lithium foil having a thickness of about 400 μm to the remaining side of the solid electrolyte layer.

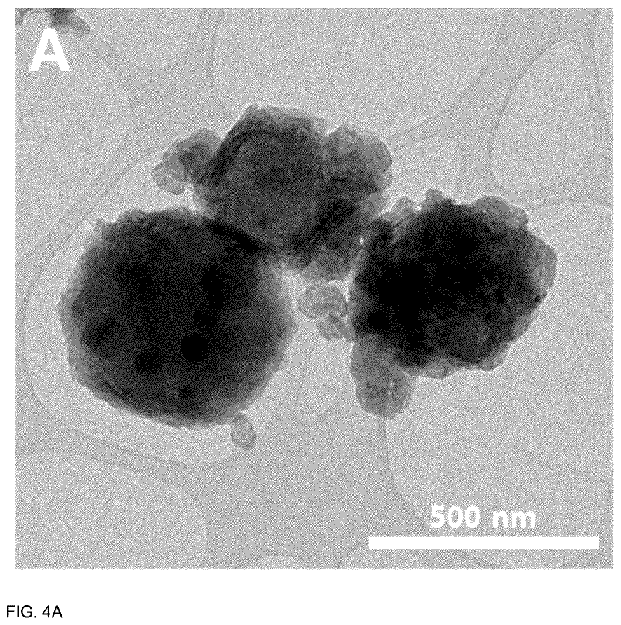

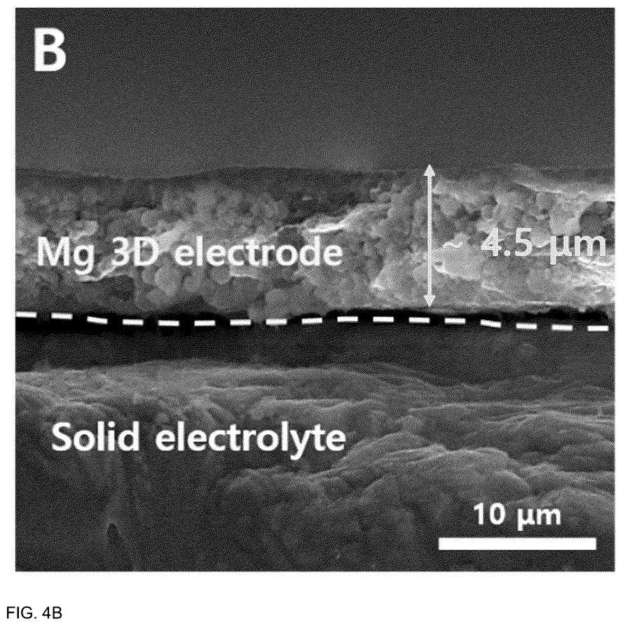

FIG. 4A is a TEM image showing the magnesium powder. The average particle size (D50) of the magnesium powder was determined to be about 500 nm.

FIG. 4B is a TEM image showing a cross-sectional view of the solid electrolyte layer and the anode layer in the half cell. The magnesium powder in the anode layer maintained the particle shape thereof. The thickness of the anode layer was about 4.5 μm.

### Comparative Example

A half cell was manufactured in the same manner as in Example 1, with the exception that nickel (Ni) powder, which does not react with lithium and does not form an alloy, was used instead of magnesium powder.

The half cell according to Example 1 was charged and discharged under the following conditions.
Operation pressure: Application of a constant pressure of about 5 MPa using a spring
Operation temperature: about 30° C.
Current: 0.5 mA/cm²
Capacity: 1 mAh/cm², 2 mAh/cm², 4 mAh/cm²

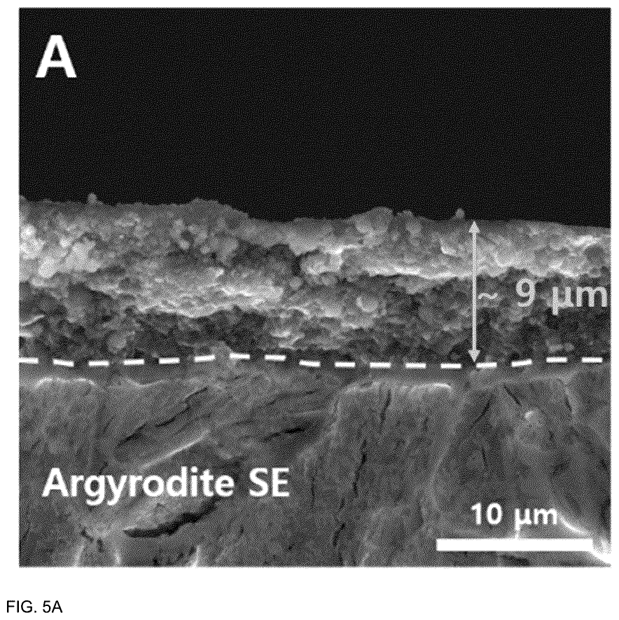

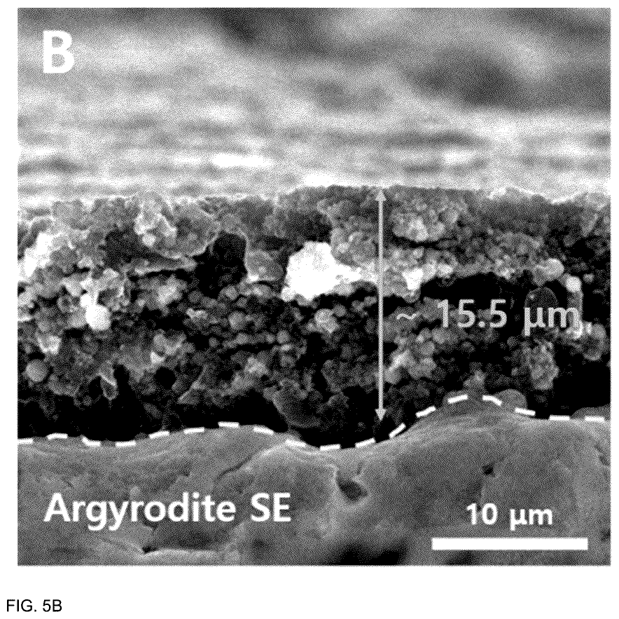

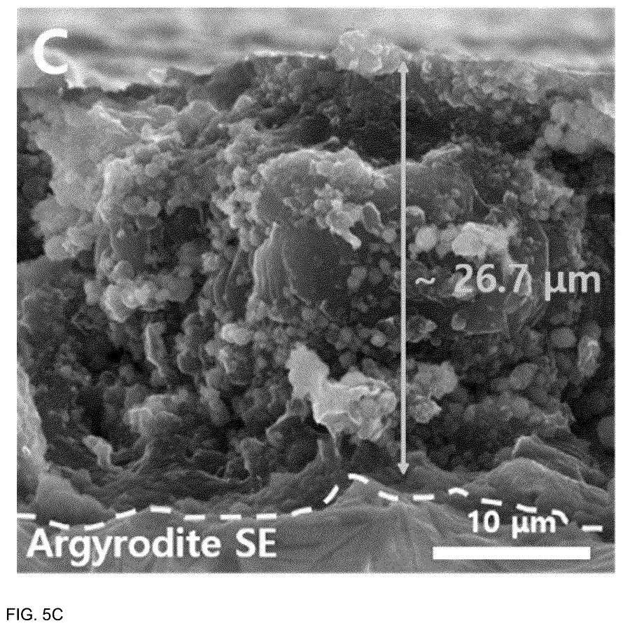

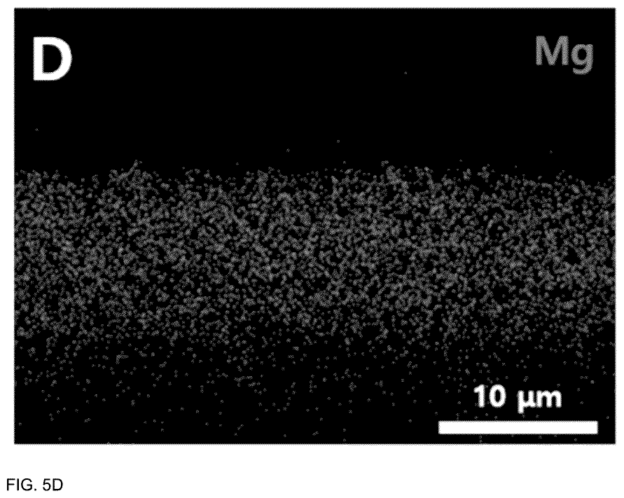

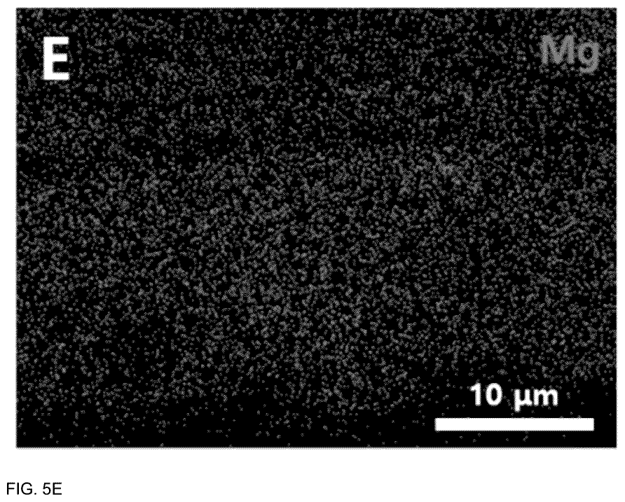

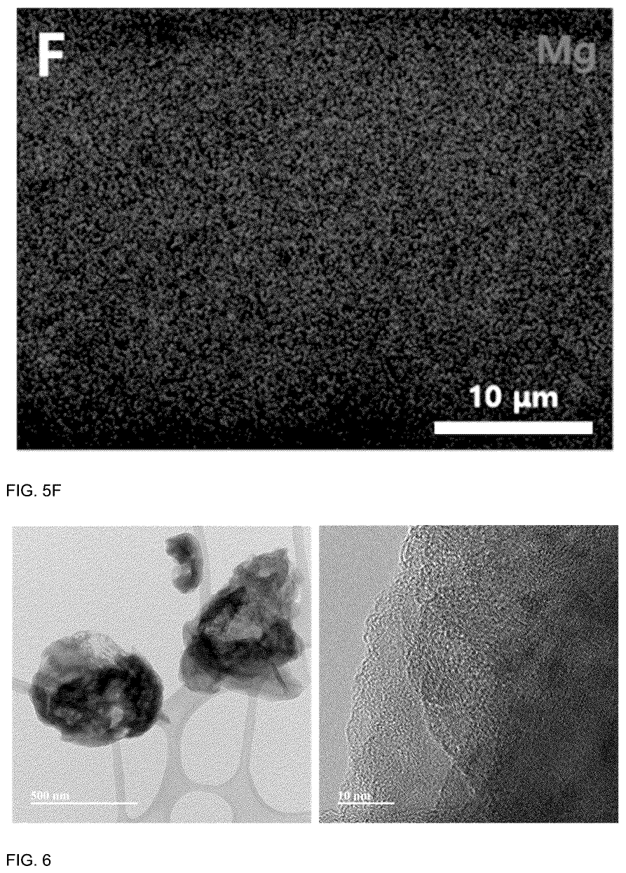

FIG. 5A is an SEM image showing a cross-sectional view of the anode layer upon charging of the half cell according to Example 1 at a capacity of 1 mAh/cm². FIG. 5B is an SEM image showing a cross-sectional view of the anode layer upon charging of the half cell according to Example 1 at a capacity of 2 mAh/cm². FIG. 5C is an SEM image showing a cross-sectional view of the anode layer upon charging of the half cell according to Example 1 at a capacity of 4 mAh/cm². Here, the thickness of the anode layer increased with an increase in capacity. Specifically, when the capacity was 1 mAh/cm², the thickness of the anode layer was about 9 μm; when the capacity was 2 mAh/cm², the thickness of the anode layer was about 15.5 μm; and when the capacity was 4 mAh/cm², the thickness of the anode layer was about 26.4 μm. The initial thickness of the anode layer was about 4.5 μm, indicating that the thickness thereof was increased by at least about 5 times during charging of the all-solid-state battery according to Example 1.

FIG. 5D shows results of analyzing the same cross-sectional view as in FIG. 5A using an energy dispersive spectrometer (EDS). FIG. 5E shows results of analyzing the same cross-sectional view as in FIG. 5B using an energy dispersive spectrometer. FIG. 5F shows results of analyzing the same cross-sectional view as in FIG. 5C using an energy dispersive spectrometer. Here, lithium metal was accommodated in a state in which magnesium was uniformly spread in the anode layer. As can be seen from FIG. 5D to FIG. 5F, the interparticular pores were enlarged with an increase in the distance between the magnesium particles and also lithium metal was accommodated in the interparticular pores.

FIG. 6 is TEM images showing the particles removed from the anode layer that is charged upon 10 charging/discharging cycles of the half cell according to Example 1. The particles maintained a spherical shape even after charging/discharging, and a lattice of an alloy of magnesium and lithium was observed.

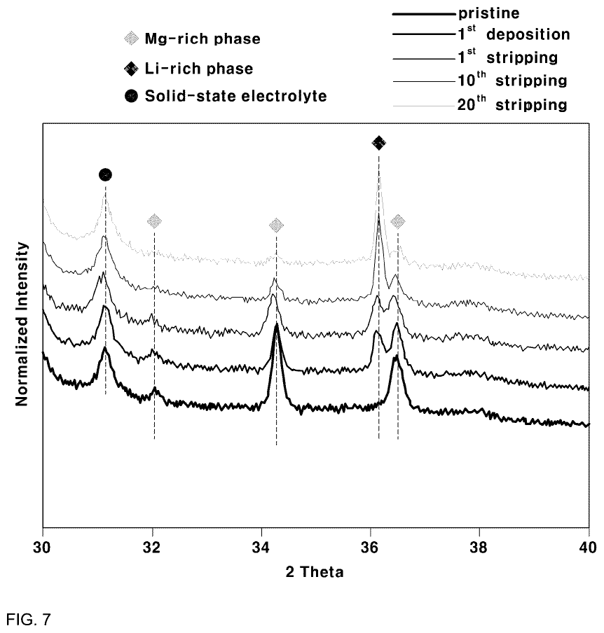

FIG. 7 shows results of X-ray diffraction analysis of the anode layer of the half cell according to Example 1. The results of the anode layer in the initial state before charging/discharging (pristine), the anode layer upon charging once (1^{st} deposition), the anode layer upon discharging once (1^{st} stripping), the anode layer upon discharging 10 times (10^{th} stripping), and the anode layer upon discharging 20 times (20^{th} stripping) are shown. The alloy phase of magnesium and lithium includes a magnesium-rich (Mg-rich) a phase and a lithium-rich (Li-rich) β phase. With the progress of charging/discharging, the intensity of peaks (peaks at 2θ=32°±0.5°, 34°±0.5°, and) 37°±0.5° due to the Mg-rich a phase decreased, and the intensity of peaks (peaks at 2θ=36)°±0.5° due to the Li-rich β phase increased. Briefly, magnesium and lithium were alloyed to form particles even upon the first charging, after which the amount of the alloy of magnesium and lithium was increased with the progress of charging/discharging.

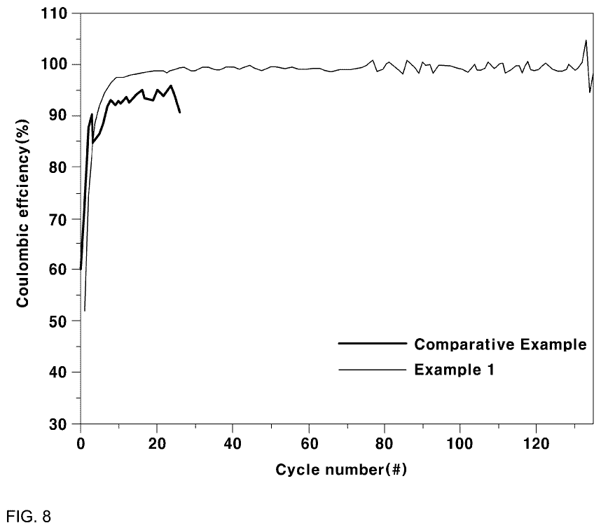

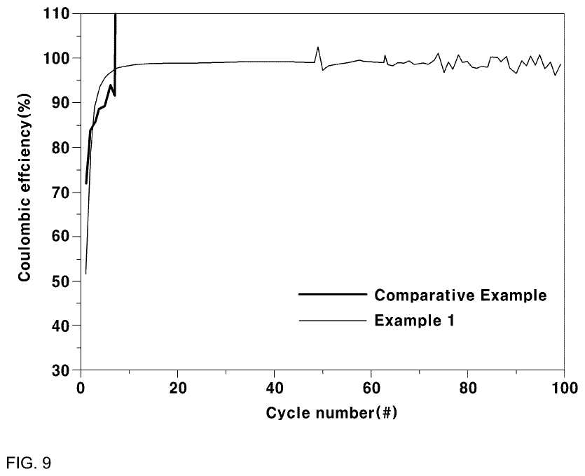

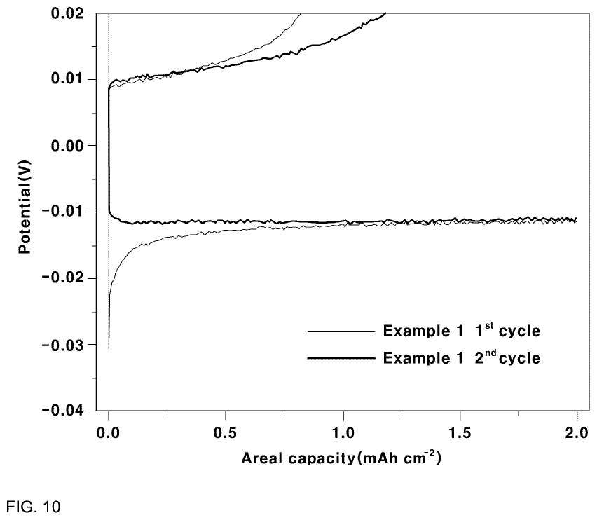

FIG. 8 shows results of measuring Coulombic efficiency upon charging/discharging of the half cells according to Example 1 and Comparative Example under conditions of 0.5 mA/cm² and 1 mAh/cm². FIG. 9 shows results of measuring Coulombic efficiency upon charging/discharging of the half cells according to Example 1 and Comparative Example under conditions of 0.5 mA/cm² and 2 mAh/cm². With reference thereto, Example 1 exhibited average Coulombic efficiencies of 98.26% and 97.97% and stable operation for 140 cycles and 100 cycles, respectively, in FIGS. 8 and 9.

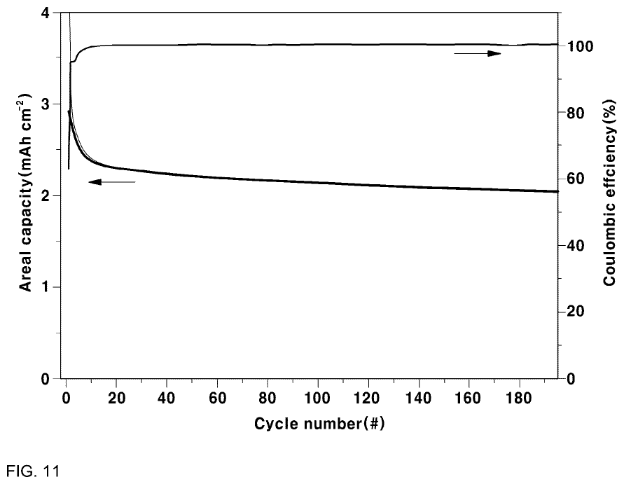

FIG. 10 shows voltage profiles in the first cycle and the second cycle upon charging/discharging of the half cell according to Example 1 under conditions of 0.5 mA/cm² and 2 mAh/cm². Example 1 exhibited nucleation overpotential in the form of (V) in the first cycle, but exhibited overpotential in the form of (L) from the second cycle. This means that stabilization of lithium deposition proceeded by forming an alloy with magnesium after the first cycle in which lithium nucleation was first performed.

### Example 2

A full cell with lithium metal as a counter electrode was manufactured as follows.

A solid electrolyte layer was formed by placing about 90 mg of L₆PS₅Cl_{0.5}Br_{0.5} powder in a mold having an inner diameter of about 10 mm and pressing the same at about 200 MPa. An anode layer was formed by placing magnesium powder on one side of the solid electrolyte layer and pressing the same at about 380 MPa. A cathode active material layer was formed by placing 20 mg of a mixed powder including a cathode active material, a solid electrolyte, and a conductive material on the remaining side of the solid electrolyte layer and pressing the same at about 380 MPa. The cathode active material used was NCM 811 coated with LiNbO₂, the solid electrolyte used was L₆PS₅Cl_{0.5}Br_{0.5}, and the conductive material used was SC65 carbon. The mixed powder was prepared by adding 3 parts by weight of the conductive material to 100 parts by weight of a powder mixture including the cathode active material and the solid electrolyte in a mass ratio of 7:3.

The full cell according to Example 2 was charged and discharged under the following conditions.
Operation pressure: Application of a constant pressure of about 30 MPa using a cell operation kit
Operation temperature: about 30° C.
Current and capacity: 0.5 mA/cm², cut-off voltage of 3 V-4.3 V

FIG. 11 is a graph showing cycle-capacity and cycle-Coulombic efficiency of the full cell according to Example 2. With reference thereto, Example 2 exhibited stable operation 190 cycles or more. In particular, Example 2 exhibited high capacity retention of about 86.1% for 180 cycles except for initial 10 cycles where the irreversible effect is large, and also exhibited very high average Coulombic efficiency of about 99.92% during intercalation/deintercalation of lithium to/from the anode layer except for the initial 10 cycles.

As is apparent from the above description, according to the present disclosure, an all-solid-state battery including an anode layer capable of accommodating a large amount of lithium metal during charging can be obtained.

According to the present disclosure, an all-solid-state battery with high Coulombic efficiency and long lifespan can be obtained.

The effects of the present disclosure are not limited to the above-mentioned effects. It should be understood that the effects of the present disclosure include all effects that can be inferred from the description of the present disclosure.

As the test examples and implementations of the present disclosure have been described in detail above, the scope of the present disclosure is not limited to the above-described test examples and implementations, and various modifications and improvements made by those skilled in the art using the basic concept of the present disclosure defined in the following claims are also within the scope of the present disclosure.

What is claimed is:

1. An all-solid-state battery, comprising:
an anode current collector;
an anode layer disposed on the anode current collector;
a solid electrolyte layer disposed on the anode layer;
a cathode active material layer disposed on the solid electrolyte layer; and
a cathode current collector disposed on the cathode active material layer,
wherein the anode layer comprises (i) particles comprising a metal capable of alloying with lithium and (ii) interparticular pores.

2. The all-solid-state battery of claim 1, wherein the metal comprises at least one of magnesium (Mg), silver (Ag), zinc (Zn), bismuth (Bi), tin (Sn), or combinations thereof.

3. The all-solid-state battery of claim 1, wherein an average particle size (D50) of the particles is 300 nm to 700 nm.

4. The all-solid-state battery of claim 1, wherein the particles are configured to maintain a spherical or elliptical shape in the anode layer.

5. The all-solid-state battery of claim 1, wherein the anode layer is formed solely by the particles.

6. The all-solid-state battery of claim 1, wherein the particles further comprise an alloy of the metal and lithium.

7. The all-solid-state battery of claim 1, wherein lithium metal is accommodated in the interparticular pores during charging of the all-solid-state battery.

8. The all-solid-state battery of claim 1, wherein alloying between the particles and lithium occurs during charging of the all-solid-state battery.

9. The all-solid-state battery of claim 1, wherein, during charging of the all-solid-state battery, lithium metal is deposited on a surface of the particles to thereby (i) increase a distance between the particles, (ii) enlarge the interparticular pores, and (iii) accommodate the lithium metal in the interparticular pores.

10. The all-solid-state battery of claim 1, wherein the anode layer satisfies Equation 1 below:
$$2 \leq {T}_{2} / {T}_{1} \leq 5.9 \qquad [ Equation 1 ]$$
wherein T₁ is a thickness of the anode layer when the all-solid-state battery is fully discharged, and T₂ is a thickness of the anode layer when the all-solid-state battery is fully charged.

11. The all-solid-state battery of claim 1, wherein intensity of peaks at 2θ=32°±0.5°, 34°±0.5°, and 37°±0.5° based on X-ray diffraction analysis of the anode layer decreases with progress of charging and discharging.

12. The all-solid-state battery of claim 1, wherein intensity of peaks at 2θ=36°±0.5° based on X-ray diffraction analysis of the anode layer increases with progress of charging and discharging.

13. A method of operation of the all-solid-state battery of claim 1, comprising performing charging and discharging at 25° C. to 45° C.
